(19) United States
(12) Patent Application Publication
(10) Pub. No.: US 2014/0274209 A1
(43) Pub. Date: Sep. 18, 2014

(54) LABEL CONFIGURED TO OPERATE BETWEEN A PLURALITY OF OPERATIVE POSITIONS

(71) Applicant: MOTOROLA MOBILITY LLC, Libertyville, IL (US)

(72) Inventors: TIM SUTHERLAND, GURNEE, IL (US); PAUL FORDHAM, WAUCONDA, IL (US)

(73) Assignee: MOTOROLA MOBILITY LLC, LIBERTYVILLE, IL (US)

(21) Appl. No.: 14/031,721

(22) Filed: Sep. 19, 2013

Related U.S. Application Data
(60) Provisional application No. 61/789,691, filed on Mar. 15, 2013.

(51) Int. Cl. H04M 1/02

(52) U.S. Cl. CPC H04M 1/026
USPC 455/558

(57) ABSTRACT

Arrangements described herein relate to presenting a label in a mobile station. The label can be configured to operate within the mobile station between a second operative position resulting from a subscriber identity module (SIM) being present in the mobile station and a first operative position resulting from the SIM not being present in the mobile station, in the second operative position the label not being externally viewable with respect to the mobile station, and in the first operative position the label being externally viewable with respect to the mobile station.

### CROSS-REFERENCE TO RELATED APPLICATIONS

This application claims the benefit of application No. 61/789,691, filed on Mar. 15, 2013, which is fully incorporated herein by reference.

### BACKGROUND OF THE INVENTION

An International Mobile Station Equipment Identity (IMEI) is a series of alphanumeric characters, for example numbers, used to identify certain types of mobile stations, for example 3rd Generation Partnership Project (3G) mobile phones, fourth generation (4G) mobile stations, Integrated Digital Enhanced Network (iDEN) mobile phones and satellite phones. The IMEI typically is unique to each mobile station.

The IMEI is used by a communications network, for example a Global System for Mobile Communications (GSM) network, to identify valid mobile stations. Mobile stations with an invalid IMEI can be prevented from accessing the communications network. For example, if a mobile station is stolen, the owner can contact his or her network provider to blacklist the mobile station using its IMEI number. This renders the mobile station useless on that network, and sometimes renders the mobile station useless on other networks as well.

### BRIEF DESCRIPTION OF THE DRAWINGS

FIG. 1 depicts a mobile station, which is useful for understanding various arrangements described herein.

FIG. 2 is an enlarged section view of the mobile station of FIG. 1, which is useful for understanding various arrangements described herein.

FIG. 3 is an enlarged section view of the mobile station of FIG. 1, which is useful for understanding various arrangements described herein.

FIG. 4 is a flowchart presenting a method of presenting a label in a mobile station, which is useful for understanding various arrangements described herein.

### DETAILED DESCRIPTION

While the specification concludes with claims defining features of the embodiments described herein that are regarded as novel, it is believed that these embodiments will be better understood from a consideration of the description in conjunction with the drawings. As required, detailed arrangements of the present embodiments are disclosed herein; however, it is to be understood that the disclosed arrangements are merely exemplary of the embodiments, which can be embodied in various forms. Therefore, specific structural and functional details disclosed herein are not to be interpreted as limiting, but merely as a basis for the claims and as a representative basis for teaching one skilled in the art to variously employ the present embodiments in virtually any appropriately detailed structure. Further, the terms and phrases used herein are not intended to be limiting but rather to provide an understandable description of the present arrangements.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

Arrangements described herein relate to mobile station including a label, for example an International Mobile Station Equipment Identity (IMEI) label. The label can be configured to operate within the mobile station between a second operative position in which the label is not externally viewable, with respect to the mobile station, and a first operative position in which the label is externally visible, with respect to the mobile station, through an aperture in the mobile station configured to receive a subscriber identity module (SIM).

The label can be configured so that when the SIM is inserted into the mobile station, the label flexes from the first operative position into the second operative position. The SIM can be attached to a SIM card. Optionally, the SIM card can be attached to a SIM holder. In this regard, the SIM card or SIM holder can engage the label, causing flexure of the IMEI when the SIM card or SIM holder is inserted into the mobile station. The SIM card, SIM holder or a door can cover, at least in part, the aperture when the SIM or SIM holder is completely inserted.

When the SIM is removed, the label can return from second operative position to the first operative position so that the label is externally visible, with respect to the mobile station, through the aperture. In illustration, the label can comprise a resilient plastic material, for example a polyester film (e.g., Mylar®), or any other suitable resilient material, biased in the first operative position. Thus, when the SIM is removed, the SIM card or the SIM holder can cease to engage the label, and the resiliency of the plastic material can cause the label to return to the first operative position.

Accordingly, even if the charge of the mobile station's battery has decreased below a level required to execute the mobile station's operating system, a user can remove the SIM (e.g., the SIM card or SIM holder) to cause the label to return to the first operative position. Thus, the user will be able to view the IMEI presented by the label, even while the mobile station is powered off. Having access to the IMEI, even while the mobile station is powered off, can be especially beneficial to the user when contacting a communication service provider who requests the user to indicate the IMEI assigned to the mobile station.

Several definitions that apply throughout this document will now be presented.

As used herein, the term “mobile station” means a mobile communication device. Examples of mobile stations include, but are not limited to, smart phones, mobile phones, satellite phones, and the like.

As used herein, the term “label” means a structure that presents alphanumeric characters (e.g., numbers and/or characters), and/or symbols. A label can, for example, comprise a flexible plastic resiliently biased to a first shape (i.e., a first operative position), and be capable of flexing to a second, different, shape (i.e., a second operative position) when a force is applied to the plastic, and returning, at least substantially, from the second shape to the first shape when the force no longer is applied to the plastic.

As used herein, the term “IMEI label” means a label that presents an “International Mobile Station Equipment Identity” (IMEI). For example, the IMEI can be printed on the label or attached to the label in a suitable manner.

As used herein, the term “International Mobile Station Equipment Identity” (hereinafter “IMEI”) means a series of alphanumeric characters (e.g., numbers and/or characters) and/or symbols that identify a particular mobile station. For example, an IMEI can be a series of numbers, a series of letters, a series of numbers and letters, or the like.

As used herein, the term “subscriber identity module” (hereinafter “SIM”) means an integrated circuit that stores an international mobile subscriber identity (IMSI) used to identify and authenticate a subscriber on mobile telephony devices. A SIM also may store a related key used in the authentication process. Another term sometimes used for “subscriber identity module” is “subscriber identification module,” which uses the same acronym “SIM.” A SIM typically is attached to, or integrated with, a printed circuit board known as a SIM card.

As used herein, the term “SIM holder” means a structure configured to hold a SIM. For example, a SIM card can be attached to a SIM holder, and the SIM holder can be inserted into a mobile station in order to insert the SIM into the mobile station. By virtue of the SIM card being attached to the SIM holder, the SIM holder can hold the SIM. An example of a SIM holder is a structure comprising a SIM tray into which a SIM is inserted, though the present arrangements are not limited in this regard.

As used herein, the term “externally viewable with respect to the mobile station” means viewable when viewing the mobile station from a position external to the mobile station (e.g., not viewing from a position within a cavity defined by a housing of the mobile station) when one or more covers for a back side of the mobile station, if any, each are in place.

FIG. 1 depicts a mobile station 100, which is useful for understanding various arrangements described herein. The mobile station 100 can include a housing 102 including at least a front side 104, a back side 106 and peripheral sides 108, 110, 112, 114 disposed between the front side 104 and the back side 106.

The front side 104 of the mobile station 100 can have defined therein an aperture 116 in which a display 118 resides. The back side 106 of the mobile station 100 can be generally parallel to, and offset, from the front side 104. As used herein, the term “generally parallel” does not require that the front side 104 and the back side 106 be planar. For example, the back side 106 can be curved, but still be generally parallel to the front side 104.

An aperture 120 can be defined in at least one of the sides 108-114, for example in the side 108, through which a SIM 122 can be inserted into the mobile station 100. In this regard, the aperture 120 can be configured to receive the SIM 122.

The SIM 122 can be attached to, or integrated with, a SIM card 124. Thus, to insert the SIM 122 into the mobile station 100, the SIM card 124 can be inserted into the mobile station 100. In one arrangement, the SIM 122, or SIM card 124, can be attached to a SIM holder 126. In illustration, the SIM holder 126 can comprise a SIM tray 128 to which the SIM card 124 is removably attached. Thus, to insert the SIM 122 into the mobile station 100, the SIM holder 126, having the SIM 122 attached thereto, can be inserted into the mobile station 100. In one arrangement, the SIM holder 126 further can comprise a SIM door 130. In another arrangement, the SIM door 130 can be hingedly attached to the side 108 in a manner that allows the SIM door 130 to be opened to insert the SIM 122 (e.g., via the SIM card 124 and/or the SIM holder 126) and closed after the SIM 122 is inserted into the mobile station 100.

When the SIM 122 is not inserted into the mobile station 100, a label 132, for example an IMEI label 132, can be externally viewable with respect to the mobile station 100. For example, if the SIM holder 126 includes the SIM door 130, the label 132 can be externally viewable with respect to the mobile station 100, through the aperture 120, while the SIM holder 126 remains separated from the mobile station 100. In this regard, when the SIM 122 is not inserted into the mobile station 100, the label 132 can be in a first operative position resulting from the SIM not being present in the mobile station 100. If, however, the SIM door 130 is hingedly attached to the side 108, the label 132 can be externally viewable with respect to the mobile station 100 when the SIM door 130 is hingedly open. The label 132 can present a unique IMEI assigned to the mobile station 100, which is viewable on the label 132 when the label 132 is viewed through the aperture 120.

When the SIM 122 is inserted into the mobile station 100, the label 132 is not externally viewable with respect to the mobile station 100, and thus the IMEI assigned to the mobile station is not viewable. In this regard, when the SIM 122 is inserted into the mobile station 100, the label 132 can be in a second operative position resulting from the SIM being present in the mobile station 100.

FIG. 2 is an enlarged section view of the mobile station 100 of FIG. 1, taken along section line 2-2, when the SIM 122 is not present in the mobile station 100. As noted, when the SIM 122 is not present in the mobile station 100, the label 132 can be in the first operative position. For example, if the shape of the label 132 is planar in its default state, the label 132 can be planar in the first operative position. In another example (not shown), if the shape of the label 132 in its default state is a shape with two sides connected perpendicularly, the label 132 can have such shape in the first operative position. Still, the default state of the label 132 can have any other suitable shape and the present arrangements are not limited in this regard. In this regard, the label 132 can comprise a resilient plastic material, for example a polyester film (e.g., Mylar®), or any other suitable resilient material, biased in the first operative position.

In one arrangement, an IMEI can be presented on a portion 202 of the label 132 immediately proximate to the aperture 120 so that the IMEI is visible through the aperture 120 when the SIM 122 is not present in the mobile station 100. If, rather than being attached to the SIM holder 126, the SIM door 130 is hingedly attached to the side 108 of the mobile station 100, the portion 202 of the label 132 can be visible through the aperture 120 when the SIM 122 is not present in the mobile station 100 and the SIM door 130 is open.

The label 132 can be fixed within the mobile station 100, for example to an internal surface 204 of the mobile station 100 opposing an external surface 206 defining the peripheral side 108. The label 132 can be fixed to the internal surface 204 in any suitable manner. For example, an internal structure 208 can be provided within the mobile station 100, offset from the internal surface 204, to define a channel 210. The label 132 can be glued with a suitable adhesive or pressed into the channel 210. In another arrangement, the label 132 can have defined therein one or more apertures (not shown) through which one or more plastic nubs (not shown) protrude, and ends of the plastic nubs protruding through the apertures can be melted so that the ends of the plastic nubs are larger than the apertures, and press the label 132 against the internal surface 204. Still, the label 132 can be fixed within the mobile station 100 in any other suitable manner and the present arrangements are not limited in this regard.

FIG. 3 is an enlarged section view of the mobile station 100 of FIG. 1, taken along section line 2-2, when the SIM 122 is present in the mobile station 100. When the SIM 122 is present in the mobile station 100, the SIM holder 126, or the SIM card 124 if a SIM holder is not used, can engage the label 132 when the SIM 122 is inserted into the mobile station 100. The SIM holder 126 or the SIM card 124, when inserted, can apply a force to the label 132, causing the label 132 to flex so that the portion 202 of the label 132 moves away from the aperture 120, thus operating the label 132 to change from the first operative position to a second operative position. In this regard, flexure of the label 132 can be due to the SIM holder 126 or the SIM card 124 engaging the plastic material comprised by the label 132 when the SIM 122 is inserted into the mobile station 100.

In illustration, the portion 202 can pivot about a portion 302 of the label 132, away from the aperture 120, while a portion 304 of the label 132 remains fixed to the internal surface 204. Moreover, the SIM door 130 can, at least in part, block viewing into the mobile station 100 through the aperture 120. Accordingly, the label 132 will not be externally viewable with respect to the mobile station 100 when the SIM 122 is inserted into the mobile station 100.

The SIM 122 can interface with the mobile station 100 in any suitable manner. For example, the mobile station can include a SIM connector 306, internal to the housing 102, that receives the SIM 122, the SIM card 124 or the SIM holder 126 (e.g., the tray 128), and communicatively links the SIM 122 to a processor or controller (not shown) of the mobile station 100. The SIM connector 306 can maintain the SIM 122, the SIM card 124 or the SIM holder 126 in place until a user desires to remove the SIM 122 from the mobile station 100. SIM connectors are well known to those skilled in the art.

At some point in time the SIM 122 may be removed from the mobile station 100, for example, when the SIM holder 126 or SIM card 124 is removed from the mobile station 100. When this occurs, the label 132 can operate to return from the second operative position depicted in FIG. 3, at least substantially, to the first operative position depicted in FIGS. 1 and 2. Such operation can be facilitated by a resiliency of the material comprised by the label 132. For example, as noted, the label 132 can comprise a resilient plastic material biased in the first operative position. Thus, when the SIM holder 126 or SIM card 124 is removed from the mobile station 100, the bias of the resilient plastic material can cause the label 132 to operate in a manner that causes the label 132 to return from the second operative position to the first operative position. Accordingly, the label 132, for example a portion 202 of the label 132 that presents the IMEI, will be externally viewable with respect to the mobile station 100.

FIG. 4 is a flowchart presenting a method 400 of presenting a label in a mobile station, which is useful for understanding various arrangements described herein. At step 402, a label can be configured to operate within a mobile station between a second operative position resulting from a SIM being present in the mobile station and a first operative position resulting from the SIM not being present in the mobile station, in the second operative position the label not being externally viewable with respect to the mobile station, and in the first operative position the label being externally viewable with respect to the mobile station. At step 404, responsive to the SIM being inserted into the mobile station, the label can operate from the first operative position to the second operative position. As noted, in the second operative position, the label is not externally viewable with respect to the mobile station. At step 406, responsive to the SIM being removed from the mobile station, the label can operate from the second operative position to the first operative position. As noted, in the first operative position, the label is externally viewable with respect to the mobile station.

Like numbers have been used to refer to the same items throughout this specification. The terminology used herein is for the purpose of describing particular embodiments only and is not intended to be limiting of the invention. The terms “a” and “an,” as used herein, are defined as one or more than one. The term “plurality,” as used herein, is defined as two or more than two. The term “another,” as used herein, is defined as at least a second or more. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The terms “including” and/or “having,” as used herein, are defined as comprising (i.e. open language). It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one arrangement,” “an arrangement,” or similar language means that a particular feature, structure, or characteristic described in connection with the embodiment is included in at least one arrangement disclosed within this specification. Thus, appearances of the phrases “in one arrangement,” “in an arrangement,” and similar language throughout this specification may, but do not necessarily, all refer to the same arrangement.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

These embodiments can be embodied in other forms without departing from the spirit or essential attributes thereof. Accordingly, reference should be made to the following claims, rather than to the foregoing specification, as indicating the scope of the embodiments.

What is claimed is:

1. A method of presenting a label in a mobile station, the method comprising:
configuring the label to operate within the mobile station between a second operative position resulting from a subscriber identity module (SIM) being present in the mobile station and a first operative position resulting from the SIM not being present in the mobile station, in the second operative position the label not being externally viewable with respect to the mobile station, and in the first operative position the label being externally viewable with respect to the mobile station.

2. The method of claim 1, wherein in the first operative position the label is externally viewable through an aperture in the mobile station configured to receive the SIM.

3. The method of claim 2, wherein a portion of the label viewable through the aperture presents an International Mobile Station Equipment Identity of the mobile station.

4. The method of claim 2, wherein the aperture is defined in a peripheral side of a housing of the mobile station, the peripheral side disposed between a front side of the housing and a back side of the housing, the front side of the housing having defined therein an aperture in which a display resides and the back side of the mobile station generally parallel to, and offset from, the front side.

5. The method of claim 4, wherein configuring the label to operate within the mobile station comprises fixing the label to an internal surface of the mobile station opposing an external surface defining the peripheral side.

6. The method of claim 1, wherein:
the label comprises a plastic material resiliently biased in the first operative position, the plastic material flexing to the second operative position when the SIM is inserted into the mobile station and returning, at least substantially, to the first operative position when the SIM is removed from the mobile station.

7. The method of claim 6, wherein the plastic material flexing is due to a SIM holder, which holds the SIM, engaging the plastic material when the SIM is inserted into the mobile station.

8. The method of claim 6, wherein the plastic material flexing is due to a SIM card, to which the SIM is integrated or attached, engaging the plastic material when the SIM is inserted into the mobile station.

9. A method of presenting a label in a mobile station, the method comprising:
configuring the label to operate within the mobile station between a second operative position resulting from a subscriber identity module (SIM) being present in the mobile station and a first operative position resulting from the SIM not being present in the mobile station, in the second operative position the label not being externally viewable with respect to the mobile station, and in the first operative position the label being externally viewable with respect to the mobile station through an aperture in the mobile station configured to receive the SIM.

10. The method of claim 9, wherein a portion of the label viewable through the aperture presents an IMEI of the mobile station.

11. The method of claim 9, wherein the aperture is defined in a peripheral side of a housing of the mobile station, the peripheral side disposed between a front side of the housing and a back side of the housing, the front side of the housing having defined therein an aperture in which a display resides and the back side of the mobile station generally parallel to, and offset from, the front side.

12. The method of claim 11, wherein configuring the label to operate within the mobile station comprises fixing the label to an internal surface of the mobile station opposing an external surface defining the peripheral side.

13. A mobile station comprising:
a label configured to operate within the mobile station between a second operative position resulting from a subscriber identity module (SIM) being present in the mobile station and a first operative position resulting from the SIM not being present in the mobile station, in the second operative position the label not being externally viewable with respect to the mobile station, and in the first operative position the label being externally viewable with respect to the mobile station.

14. The mobile station of claim 13, wherein in the first operative position the label is externally viewable through an aperture in the mobile station configured to receive the SIM.

15. The mobile station of claim 14, wherein a portion of the label viewable through the aperture presents an International Mobile Station Equipment Identity of the mobile station.

16. The mobile station of claim 14, wherein the aperture is defined in a peripheral side of a housing of the mobile station, the peripheral side disposed between a front side of the housing and a back side of the housing, the front side of the housing having defined therein an aperture in which a display resides and the back side of the mobile station generally parallel to, and offset from, the front side.

17. The mobile station of claim 16, wherein configuring the label to operate within the mobile station comprises fixing the label to an internal surface of the mobile station opposing an external surface defining the peripheral side.

18. The mobile station of claim 13, wherein:
the label comprises a plastic material resiliently biased in the first operative position, the plastic material flexing to the second operative position when the SIM is inserted into the mobile station and returning, at least substantially, to the first operative position when the SIM is removed from the mobile station.

19. The mobile station of claim 18, wherein the plastic material flexing is due to a SIM holder, which holds the SIM, engaging the plastic material when the SIM is inserted into the mobile station.

20. The mobile station of claim 18, wherein the plastic material flexing is due to a SIM card, to which the SIM is integrated or attached, engaging the plastic material when the SIM is inserted into the mobile station.
